(19) United States
(12) Patent Application Publication
(10) Pub. No.: US 2017/0068803 A1
(43) Pub. Date: Mar. 9, 2017

(54) SYSTEMS AND METHODS FOR RECORDING A COLLECTION OF A SAMPLE OF A PATIENT

(71) Applicant: Sanis Biomedical LLC, Mandeville, LA (US)

(72) Inventors: Clayton B. Ford, New Orleans, LA (US); Pleasant F. Hooper, New Orleans, LA (US)

(73) Assignee: Sanis Biomedical LLC, Mandeville, LA (US)

(21) Appl. No.: 15/253,954

(22) Filed: Sep. 1, 2016

Related U.S. Application Data
(60) Provisional application No. 62/214,542, filed on Sep. 4, 2015.

(51) Int. Cl. G06F 19/00; G06Q 10/08

(52) U.S. Cl. CPC G06F 19/366; G06Q 10/0832

(57) ABSTRACT

The systems and methods described herein provide a SmartTube collection and logging technique of a patient's (or clinical trial participant/subject) action of self-collection of a biologic sample during a sample collection event. The system for recording the sample collection event may include a shipping container comprising a sensor area, a switch and a microcontroller and sample collector positioned on the sensor area of the shipping container. The removal of the sample collector from the sensor area can change a state of the switch to a first state and the return of the sample collector to the sensor area can change the state of the switch to a second state during the sample collection event. The microcontroller can be coupled to the switch to receive a signal from the switch indicating the change in state.

### CROSS-REFERENCE TO RELATED APPLICATION

The present application claims the benefit of U.S. Provisional Application 62/214,542, titled “SYSTEMS AND METHODS FOR RECORDING A COLLECTION SAMPLE OF A PATIENT,” filed on Sep. 4, 2015. The entire disclosure of which is hereby incorporated herein by reference in its entirety.

### BACKGROUND

The necessity of date and time information is critical for pharmaceutical research studies and in therapeutic drug monitoring for clinical medical practice. Drugs exhibit pharmacokinetics and pharmacodynamics, essentially changes in concentration and biologic activity over time due to absorption, distribution across the body, metabolism, and excretion & elimination (ADME). A major determinant of effective drug action and adverse effects/side effects is the overall exposure to the drug. This may be graphically depicted as Area Under the Curve (AUC) with a plot of blood concentration of the parent drug vs. time plotted from samples taken before a dose and serially over the time from initial intake until elimination (e.g., every 2 hours over 12 hours for drug dosed every 12 hours). Since such frequent sampling can be impractical or impossible in ordinary settings, a predictive formula is derived such that the lowest concentration at just before the next dose (C0=trough level from AUC curve) is used to predict overall exposure and guides the dosage concentration prescribed. Therapeutic Drug Monitoring is used to determine C0 from patient blood samples and guide dosing. Accordingly, clinical trials of drugs require such data to ascertain the actual drug exposure individuals incur and determine effectiveness and toxicity in relation to drug exposure. Therefore, it is critical to have blood samples taken at the designated times in relation to dose ingestion—variance of even 30 minutes can dramatically alter the analysis—potentially skewing a drug trial to incorrect conclusions and loss of millions of dollars in investment. In addition, in certain situations of rapidly changing ADME, such as post-heart pediatric heart transplant patients with vigorous growth acceleration, the predictive formula may utilize C2 levels—two hours after dose—to compensate for robust absorption and altered pharmacokinetics, reinforcing the critical aspect of time of dose and time of sample collection in predicting levels of drug.

The Pharmaceutical industry (Pharma) is, of course, aware of the need for stringent recording of sampling date and time. Standard clinical trial operations employ combinations of clinical facilities such as hospitals, clinics, physician offices, and commercial phlebotomy collection centers along with contract research organizations for additional duties. These outsourced expenses are appreciable and limit trial flexibility. Pharma has attempted self-collection of blood samples by subjects with poor results—the predominate issue being incorrect recording of date and time of collection, often forgoing an early morning collection to a later time and “predating” the collection, which then corrupts the clinical data. The FDA reviewers are well aware of this problem and have notified Pharma that subjective recording of self-collection of samples would not be viewed favorably in trial analysis. Furthermore, assist strategies such as phone camera pictures with date and time stamp are not considered sufficient solutions and are vulnerable to subject error or infidelity. An additional motive is the desire to conduct clinical drug trials with flexibility which remote sample collection provides—thereby attracting subjects not currently enrolled and improving clinical trial compositions to more accurately represent the eventual patient populations targeted and potentially discover any issues before market roll out. Pharma seeks an objective record of sample self-collection to answer FDA concerns and proceed with remote trials.

### SUMMARY

The systems and methods described herein are directed towards a SmartTube technology designed to provide reliable low cost techniques for collection and logging of a clinical trial participant/subject (or patient's) action of self-collection of a biologic sample during a sample collection event. In an embodiment, the biologic sample may include blood samples (e.g., liquid blood or a matrix such as filter paper or plastic polymer for dried blood sampling), body tissue samples, urine and/or oral fluids. The sample collection event may provide an objective record of sample collection date & time information. This information is needed for analysis of pharmacologic behavior and, consequently, for regulatory agency approval of pharmaceuticals. The recording of sampling date & time can be unsatisfactory when left to subjective recording by sampling performers both due to human error and intentional alteration of time of sampling for secondary gain (convenience, financial gain, etc.). Such inaccuracies have been observed by pharmaceutical companies in pilot studies (personal communication). In addition, widely available objective recording of events, such as digital camera/smart phone camera systems with time/date “stamp” are easily manipulated by altering internal settings and are not reliable for objective sample collection logging.

In response to Pharma's needs for accurate records of date, time and other information when samples (or “specimens”) are collected, the systems and methods described herein provide a SmartTube collection and logging technique which includes a sample shipping container (referred to herein as a shipping container) and one or more sample collectors (e.g., sample tubes, collection vials, filter paper or synthetic matrix for dried blood spot collection) and associated sampling technology. The shipping container and/or sample collectors can provide an objective and accurate record of sample collection information (e.g. the date and time at which a sample is collected, patient data).

The sample collection information can be collected during the sample collection event. The sample collection event may refer to a time period during which a patient provides a sample to a sample collector. The time period may be initiated and ended by different actions as described herein. For example, the sample collection event may begin by sensing an action indicative of collection, for example and without limitation, the opening of the shipping container (e.g. movement of a container cap or lid), the detection of a removal of one or more sample collectors from the shipping container, an opening of a cap of one or more sample collectors and/or a sensor notification of a presence of fluid or other material in a collection container. The sample collection event may end by sensing an action indicative of the closing of the shipping container (e.g. movement of a container cap or lid), the detection of a replacement of one or more sample collectors into the shipping container, the closing of a cap on one or more sample collectors and/or a sensor notification of the presence of fluid or other material in a collection container.

In a first aspect, a system for recording a sample collection event comprises a shipping container comprising a sensor area, a switch and a microcontroller, and sample collector positioned on the sensor area of the shipping container. The removal of the sample collector from the sensor area can change a state of the switch to a first state and the return of the sample collector to the sensor area can change the state of the switch to a second state during the sample collection event. The microcontroller can be coupled to the switch to receive a signal from the switch indicating the change in state.

The microcontroller, responsive to receiving the signal from the switch, can change from a first power level to a second power level to record and store data corresponding to the sample collection event. A clock module may be coupled to the microcontroller. The clock module can be configured to record time data corresponding to the sample collection event and transmit the time data to the microcontroller.

A storage module can be coupled to the microcontroller. The microcontroller can be configured to generate and store logs for one or more sample collection events in the storage module. Each log may include time data, date data, patient data, sample collector data, and/or shipping container data corresponding to the respective one or more sample collection events. In some embodiments, an interface can be coupled to the microcontroller. The interface can be configured to provide data corresponding to the sample collection event to one or more computing devices coupled to the shipping container.

In some embodiments, the shipping container may comprise a plurality of sensor areas and a plurality of switches. Each sensor area may be configured to hold one or more sample collectors and each switch can be coupled to at least one sensor area. The microcontroller can be coupled to each of the plurality of switches to receive the signal from the respective switch indicating the change in state of the respective switch.

In another aspect, a system for recording a sample collection event comprises a sample collector comprising a conductive material and a cap positioned on the sample collector. The cap may comprise a conductive ring, and the conductive ring can be coupled to the conductive material of the sample collector to form a circuit between the cap and the sample collector. In an embodiment, the removal of the cap from the sample collector opens a circuit established between the cap and the sample collector and the return of the cap to the sample collector closes circuit between the cap and the sample collector.

The sample collector can be communicatively coupled to a microcontroller of a shipping container. The microcontroller can be configured to detect the opening and closing of the circuit between the cap and the sample collector and record data corresponding to the sample collection event responsive to the opening and closing of the circuit.

In some embodiments, a cap guard can be disposed over the cap. The cap guard can be configured to open and close to control access to the cap and sample collector. The microcontroller can be configured to detect the opening and the closing of the cap guard.

The sample collector may comprise at least one sensor positioned within the sample collector to detect a presence of a sample in the sample collector. The presence of the sample within the sample collector may activate a circuit between the sample and the sensor in the sample collector. The microcontroller can be configured to detect the activation of the circuit between the sample and the sensor in the sample collector and record data corresponding to the sample collection event responsive to the activation of the circuit. The sensor can be disposed on an inner surface of the sample collector. The sensor can be configured to detect, by electrical conduction, the presence of the sample inside the sample collector.

In another aspect, a method for recording a sample collection event comprises, the method detecting a removal of a sample collector from a sensor area of a shipping container, changing a state of a switch of the shipping container to a first state, detecting a return of the sample collector to the sensor area of the shipping container, changing the state of the switch of the shipping container to a second state, and calculating a time between the removal of the sample collector and the return of the sample collector.

The method may further comprise, responsive to changing the state of the switch, changing a power level of a microcontroller of the shipping container from a first level to a second level to record data corresponding to the sample collection event. In some embodiments, responsive to changing the state of the switch to the first state, changing a power level of a clock module of the shipping module from a first level to a second level to record time date corresponding to the sample collection event. Responsive to the changing the state of the switch to the second state, the power level of a microcontroller may be changed from the second level to the first level to stop recording data corresponding to the sample collection event.

The method may further comprise detecting a removal of a cap of the sample collector, the removal opening a circuit between the cap and the sample collector, detecting a return of the cap to the sample collector, the return closing the circuit between the cap and the sample collector and calculating a time between the removal of the cap and the return of the cap. A signal may be transmitted indicating at least one of the removal of the cap, the return of the cap or the time between the removal of the cap and the return of the cap to the microcontroller.

In some embodiments, a presence of a sample in the sample collector may be detected. The sample may complete a circuit between properties of the sample and conductive material coupled to an inner surface of the sample collector. A date and time when the circuit is completed in the sample collector may be calculated. The method may further comprise detecting by electrical conduction the presence of the sample inside the sample collector.

### BRIEF DESCRIPTION OF THE DRAWINGS

The foregoing features may be more fully understood from the following description of the drawings in which:

FIG. 1 is a block diagram of a SmartTube sample collector time-logging system;

FIG. 2 is a block diagram of a SmartTube shipping container having a sample collector contact switch-enabled connection;

FIG. 2A is a block diagram of a SmartTube shipping container having a container cap connection and a sample collector contact switch-enabled connection;

FIG. 3 is a block diagram of a SmartTube shipping container having a container cap connection;

FIG. 4 is a block diagram of a SmartTube sample collector having a sample-enabled connection;

FIG. 5 is a block diagram of a SmartTube sample collector having a ring cap connection;

FIG. 6 is a block diagram of a SmartTube sample collector having a cap guard enabled connection;

FIG. 7 is a flow diagram of a method for recording a sample collection event; and

FIG. 8 is a block diagram of an embodiment of a computer system for recording a sample collection event.

### DETAILED DESCRIPTION

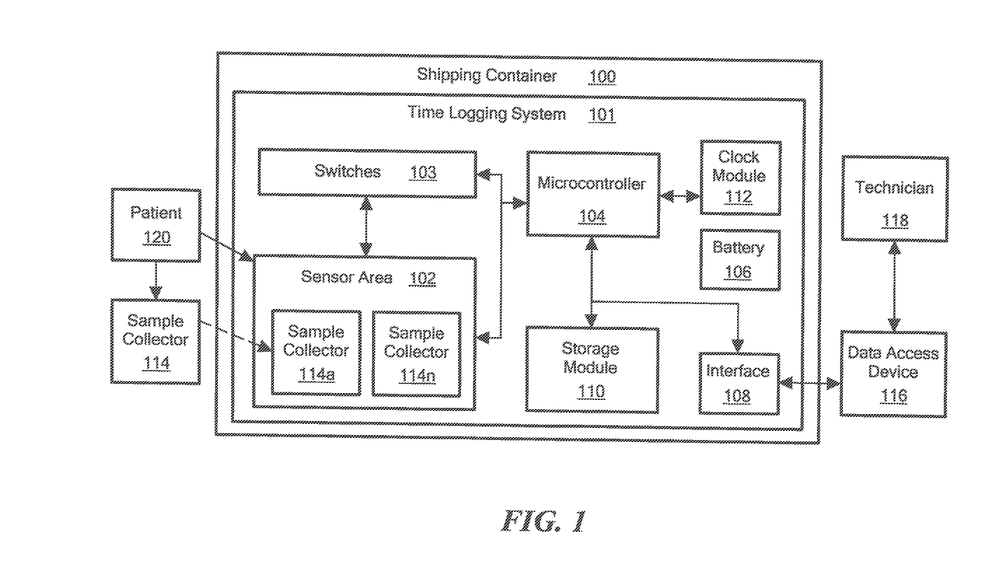

Referring now to FIG. 1, a Smart Tube shipping container 100 (hereinafter shipping container) is configured to transport one or more sample collectors 114a-114n to a patient 120 for the collection of samples (e.g., biological samples, fluid, body tissue) as part of a sample collection event. The sample collection event may refer to a time period (e.g., date and time information) during which the patient 120 provides a sample (e.g., self-collection) to one or more sample collectors 114a-114n.

The shipping container 100 includes one or more switches 103, one or more sample collectors 114a-114n disposed in a sensor area 102 (hereinafter sensor), a microcontroller 104, a power source 106, a clock module 112, a storage module 110 and an interface 108.

Shipping container 100 can be configured to detect the insertion, removal and/or replacement of one or more sample collectors 114a-114n. The entire sequence from the removal of one or more sample collectors 114a-114n from shipping container 100 to the replacement of the one or more sample collectors 114a-114n can be recorded and stored as the sample collection event in the storage module 110 (e.g., any memory device, database or other type of storage element) by microcontroller 104.

For example, patient 120 may receive shipping container 100 (e.g., in the mail) to perform self-collection of body fluids and/or tissues to be later analyzed in a lab setting by technician 118. Shipping container 100 includes one or more sample collectors 114a-114n that patient 120 can use to take a sample of body fluid (e.g., blood sample) or tissue to be analyzed at the lab. The patient 120 can remove at least one sample collector 114′ of the one or more sample collectors 114a-114n from the shipping container 100.

Patient 120 can open the sample collector 114′ and insert the appropriate sample. Patient 120 can close the sample collector 114′ and replace (e.g., re-insert) the sample collector 114′ into the sensor 102 of shipping container 100. The movement of a cap of shipping container 100 and/or movement of one or more sample collectors 114a-114n can be detected by one or more switches 103. The switches 103 can be configured to provide a signal to microcontroller 104 indicating the movement. In some embodiments, microcontroller 104 may be activated by the signal from the switches 103 and can provide a signal to clock module 112 to initiate time recording and/or end time recording.

The sequence event from the opening of the shipping container 100 and/or opening of the sample collector 114′ to the closing of the shipping container 100 and/or the closing of the sample collector 114′ may be referred to herein as a sample collection event. The microcontroller 104 can be configured to generate logs of data for each sample collection event having the corresponding date and time information and store the logs of data in storage module 110. Shipping container 100 can then be transported to the lab for technician 118 to analyze the contents within the sample collector 114′ and the logs of data (e.g., download information from shipping container 100) corresponding to each sample collection event. The period of time required to remove the sample collector 114′, fill the sample collector with a sample (e.g., blood from finger stick) and return to the sample collector 114′ to the shipping container 100 provides an objective record of a date and time periods of the sample collection event. The components of shipping container 100 and the methods involved in a sample collection event will be described in greater detail below.

Shipping container 100 can be configured to accommodate and detect the insertion, removal and/or replacement of a variety of different types of sample collectors 114. For example, shipping container 100 can be configured to accommodate whole blood sample collectors, dry blood sample collectors and/or dry blood spot cards. The sample collectors 114a-114n may be provided in a variety of different shapes, including but not limited to, round, cylindrical, tubular and/or rectangular. In some embodiments, sample collectors 114a-114n may include vials, tubes and/or any other known device for collecting body fluid and/or body tissue samples.

Shipping container 100 may include an inner container 101 to house and protect the sample collectors 114a-114n and/or circuitry of shipping container 100. The inner container 101 may include insulation material to insulate and protect the sample collectors 114a-114n and/or circuitry of shipping container 100. The insulation material may be formed on or otherwise disposed on inner walls, inner surfaces, a base portion or a top portion (e.g., container top) of inner container 101 and/or shipping container 100. The insulation material may include, but not limited to, foam padding, plastic, aluminum or other materials to insulate and protect the electronics and sample collectors 114a-114n disposed within inner container 101 and/or shipping container 100. In some embodiments, inner container 101 and/or shipping container 100 may include absorbent and/or desiccant materials to absorb any spilt fluid from the sample collectors 114a-114n. The absorbent materials may include, but not limited to, cotton, paper or other materials known to serve as an absorbent or desiccant material.

Shipping container 100 may be formed in a variety of different shapes and designs. The shape and design of shipping container 100 may be based at least in part on a shape or design of the sample collectors 114a-114n and/or the number of sample collectors 114a-114n to be disposed within shipping container 100. In some embodiments, the shipping container 100 may include a single-shelled design having an outer surface formed from a rigid or semi-rigid material. In other embodiments, the shipping container 100 may include a double-shelled design having an outer surface formed from a rigid or semi-rigid material. The shipping container 100 and/or inner container 101 may include a sealing layer or agent to seal openings or connections points, such as to prevent fluid transfer in or out of shipping container 100 and/or inner container 101 and/or to maintain a desired temperature range within shipping container 100 and/or inner container 101.

To record data associated with the sample collection event, the different components of the shipping container can be configured to detect movement and/or properties of the sample collectors 114a-114n. Sensor 102 can be configured to detect the insertion and/or replacement of one or more sample collectors 114a-114n into shipping container 100 and/or the removal of one or more sample collectors 114a-114n from shipping container 100. For example, sensor 102 may be a sensor area in inner container 101 in which one or more sample collectors 114a-114n are disposed or otherwise positioned within.

Sensor 102 may include mechanical elements to facilitate the triggering of the sample collection event. In some embodiments, one or more mechanical elements may be coupled to sensor 102 to facilitate the triggering of the sample collection event. For example, and as illustrated in FIG. 1, one or more switches 103 may be coupled to sensor 102 to detect the insertion and/or replacement of one or more sample collectors 114. The switches 103 (e.g., mechanical elements) may include, but not limited to, a lever to activate a switch, a momentary, semi-momentary, or toggle type switches. In some embodiments, at least one switch 103 may be coupled to and/or configured to detect the actions of at least one sample collector 114 disposed within shipping container 100.

Switches 103 can be coupled to the microcontroller 104, the power source 106, the clock module 112, the storage module 110 and/or the interface 108. Switches 103 can be utilized to access settings, activate a communications mode and/or provide other modifications to one or more behaviors (e.g., activate logging, de-activate logging) of the microcontroller 104, the power source 106, the clock module 112, the storage module 110 and/or the interface 108 within shipping container 100. For example, in some embodiments, one or more switches 103 can be used to power-on or power-off at least one of the microcontroller 104, the power source 106, the clock module 112, the storage module 110 and/or the interface 108.

In some embodiments, switches 103 may include a self-enclosed and independent micro switch (or other device capable of opening and closing a circuit) wired to the electronics within shipping container 100. For example, switches 103 may include a switch integrated into a circuit board within shipping container 100, either through through-hole technology, or surface mount technology. In an embodiment, using either the through through-hole technology or surface mount technology, switches 103 may be configured either in a normally activated or inactivated mode, either in a normally open or closed configuration, and may be connected to the electronics via use of a pull-up or pull-down resistor. Thus, switches 103 may be configured to sense circuit-opening or circuit-closing events within shipping container 100. For example, the movement of one or more sample collectors 114a-114n may cause a circuit-opening or circuit-closing event. In other embodiments, the opening of a cap of shipping container 100 and/or the opening of a cap of one or more sample collectors 114a-114n may cause a circuit-opening or circuit-closing event. Switches 103 can be configured to detect each of the above described circuit-opening or circuit-closing events.

The activation (e.g., initiation) of a sample collection event may include the activation of one or more switches 103. For example, different switches 103 can be configured to perform and be dedicated to different tasks within shipping container 100. A first switch 103 may be configured to monitor the movement of a sample collector 114. A second switch 103 may be configured to activate the clock module 112 within shipping container 100. A third switch 103 may be configured to activate the microcontroller 104 upon removal of one or more sample collectors 114a-114n. Thus, the activation of the sample collection event may include the activation of one or more, or a specified combination of switches 103 dedicated to either sample monitoring movement and/or monitoring behavior modification of the electronics within shipping container 100.

In some embodiments, a single switch 103 may perform multiple functions for recording the sample collection event. For example, a single switch 103 may activate event logging and activate specified behaviors (e.g. turn-on, activate) for clock module 112 and/or microcontroller 104.

In some embodiments, one or more switches 103 can be configured to deactivate event logging. For example, in one embodiment, a switch 103 can be configured to deactivate event logging before the removal of all of the sample collectors 114a-114n from shipping container 100 or de-activate logging after a pre-determined amount of sample collectors 114a-114n have been removed from shipping container 100.

Microcontroller 104 may be coupled (e.g., communicatively coupled, directly coupled) to sensor 102 and/or switches 103 to receive information related to the sample collection event. For example, sensor 102 and/or switches 103 can be configured to transmit a signal indicating that the sample collection event has been initiated, ended and/or occurred. Sensor 102 and/or switches 103 may be coupled to microcontroller 104 through one or more digital inputs on microcontroller 104. Microcontroller 104 can poll the inputs to detect a change in state.

Sensor 102 and/or switches 103 may provide a hardware interrupt (e.g., signal) to microcontroller 104 through the one or more digital inputs or a detectable change in state through digital or analog recording methods to indicate that a sample collection event has been initiated and/or ended. For example, a hardware interrupt may be triggered on microcontroller 104 from a detected rising edge, falling edge, change in logical level, or high or low detected logical level, of a signal (e.g., voltage signal) provided by sensor 102 and/or switches 103. Thus, sample collection events may be detected directly from hardware interrupts, or from constant and/or periodic polling of the state or events on the signal provided by sensor 102 and/or switches 103.

In some embodiments, such as embodiments having multiple switches 103, each of the switches 103 may be independently coupled (e.g., wired) to microcontroller 104 such that each of the switches 103 can provide an independent signal (e.g., hardware interrupt), independent of other switches. In other embodiments, the multiple switches 103 may be coupled to microcontroller 104 such that they are multiplexed to a single or multiple hardware interrupts through the use of digital logic (discrete logic, or included in another component). For example, using a combination of Boolean functions and logic gate devices (e.g., AND gates, NAND gates, OR gates, NOR gates, XOR gates, NOT gates, etc.), the switches 103 can provide single and/or multiple signals to microcontroller 104. Switches 103 may also be coupled to microcontroller 104 such that direct connection to digital inputs and the multiplexed interrupt(s) could be achieved simultaneously.

A power level of microcontroller 104 can be modified during a sample collection event. For example, to avoid energy requirements of continuous active microcontroller operation, an interrupt process can be used where microcontroller 104 remains in low-power (e.g., first power level), “sleep” or “standby” state to conserve energy, diminishing the required amount of energy to be stored in power source 106 when no sample collection event is occurring. Microcontroller 104 can remain in this low-power state (maintaining enough power consumption to be able to turn back on, as well as allowing continued power consumption to maintain the time on clock 112 (coupled to microcontroller 104) until reactivated (e.g., second power level) by a hardware interrupt indicating the initiation of a sample collection event.

In some embodiments, the removal of one or more sample collectors 114a-114n can be detected by microcontroller 104 and a changing of a state of one or more of the switches 103 awakens microcontroller 104 from a low-power state through the use of the hardware interrupt. The sample collection event may include the insertion and/or replacement of one or more sample collectors 114a-114n into shipping container 100 or removal of one or more sample collectors 114a-114n from shipping container 100.

Microcontroller 104 may include one or more electrical circuits to record and store information corresponding to the sample collection event. The information may include a time data, date data, patient data, sample collector data, and/or shipping container data corresponding to one or more sample collection events.

To determine and record date and time information, microcontroller 104 may be coupled (e.g., communicatively coupled, directly coupled) to clock module 112. Clock module 112 may include a real-time clock and be configured to provide an accurate time and date values to microcontroller 104 for each sample collection event. The time and date values may include when the sample collection event was initiated (e.g., when sample collector 114 was removed from shipping container 100), a time and date period for how long the sample collector 114 was removed from shipping container 100 and a time and date value for when the sample collection event ended (e.g., when sample collector 114 was re-inserted into shipping container 100). In some embodiments, clock module 112 can be turned on only for a duration necessary to generate time data during the sample collection event. For example, the clock module 112 may be activated upon the activation of the sample collection event.

In some embodiments, clock module 112 can record different time events within a single sample collection event. For example, when one or more sample collectors 114a-114n are removed from shipping container 100, clock module 112 can record the corresponding time for each of the one or more sample collectors 114a-114n or a combination of the one or more sample collectors 1114a-114n as sample collector removal event. When one or more sample collectors 114a-114n are replaced or returned to the sensor area 102, clock module 112 can record the corresponding time as a sample collector return event. Clock module 112 can record the time between the start of the sample collector removal event to the end of the sample collector return event as a total time for the sample collection event. In some embodiments, when the sample collection event is completed and/or the sample collector return event is completed, microcontroller 104 and/or clock module can change their respective power levels and can re-enter a low power state (e.g., first power level).

To store the sample collection event information, microcontroller 104 may be coupled (e.g., communicatively coupled, directly coupled) to storage module 110. Storage module 110 may include an electrically erasable programmable read-only memory (EEPROM), a volatile memory, non-volatile memory and/or a database. In some embodiments, microcontroller 104 may generate and store logs for one or more sample collection events. For example, microcontroller may generate one or more logs for each sample collection event.

The logs may include tables having time data, date data, patient data, sample collector data (e.g., identifiers) and/or shipping container data for the one or more sample collection events. In some embodiments, the logs may include identification information for one or more patients 120, one or more sample collectors 114a-114n and/or of the shipping container 100 itself. For example, sample collectors 114a-114n may include identifiers physically located on the sample collection device (e.g., printed labels, barcodes, QR codes, RFID chips) and this information may be stored in a respective log in storage module 110. The logs may include additional information identifying one or more samples provided by a patient 120 in the respective sample collector 114, such as an accession number for location in inventory, and other logistical identifiers and associated information that may be stored and accessed through storage module 110.

Interface 108 may provide a mechanism for patient 120 and/or technician 118 to interact with shipping container 100. In an embodiment, interface 108 may include a variety of different forms of wired and/or wireless protocols for transferring data to the data access device 116. For example, and without limitation, interface 108 may include wired coupling such as a universal serial bus (USB), serial peripheral interface (SPI), inter-integrated (12C) interface, test access port (JTAG) interface, and universal asynchronous receiver/transmitter (UART). Interface 108 may include wireless coupling, such as and without limitation, Bluetooth, WIFI, near-field communication (NFC), radio frequency identification (RFID), infrared (IR) protocols, and radio frequency (RF) protocols. In an embodiment, technician 118 may use interface 108 to access data stored in storage module 110, for example, to access the one or more logs for the one or more sample collection events.

In some embodiments, technician 118 may access the data stored in storage module 110 through a data access device 116. Data access device 166 may include any type computing device (e.g., laptops, hand held devices, tablet computing devices, etc.) and may couple to storage module 110 through interface 108. For example, interface 108 may include an asynchronous bidirectional serial interface, which is connected through the USB interface to a serial console on data access device 116.

Data access device 116 may include a user interface (e.g., GUI) to provide technician 118 the ability to obtain logs from storage module 110, obtain logs from sample collectors 114a-114n, clear logs in either storage module 110 and/or sample collectors 114a-114n and/or change settings in sensor 102, microcontroller 104, power source 106, clock module 112, storage module 110, interface 108 or a combination of them. Thus, technician 118 may use data access device 116 to interact with the components of shipping container 100. Data access device 116 may include hardware and/or software components to allow technician 118 to interact with the components of shipping container 100. For example, in some embodiments, technician 118 may utilize data access device 116 to obtain sample collection event logs, clear sample collection event logs, set clock module 112, perform time check on clock module 112, check and/or modify user access passwords, check and/or modify encryption keys for decryption or encryption purposes, check and/or modify sample collector identification information, and check and/or modify other settings or data stored on components of shipping container 100. In some embodiments, the hardware and/or software may be configured to provide bidirectional information flow with another computing device and/or piece of software, such as a Lab Information Management Software (LIMS) package installed on another computing device.

Shipping container 100 may be configured to have a communications mode to communicate with data access device 116. For example, technician 118 may attempt to access data stored within storage module 110 in a laboratory setting. The communications mode may be initiated when a connection to interface 108 is initiated. In some embodiments, communications mode may be activated through use of one or more of switches 103. For example, one or more switches may be coupled to interface 108 and thus, the switches 10 may be configured to activate interface 108.

In some embodiments, communications mode may be initiated when a connection from data access device 116 to interface 108 is established. In some embodiments, communications mode may be initiated responsive to the connection to interface 108 followed by the detection of a log record of removal and/or replacement of sample collector 114 (e.g., a connection of a serial interface from data access device 116 to interface 108 via a USB adapter and access of data log records). Fulfillment of those conditions in that order may be used to differentiate activating of communications mode versus a sample collection event (e.g., when a sample collector is removed by patient 120). Communications mode may be exited when a new sample collector 114 is inserted into shipping container 100, the previous sample collector 114 is returned and/or when the connection to interface 108 is disconnected.

Technician 118 may utilize interface 118 to perform administrative tasks, such as verifying and/or correcting time information in clock module 112 and/or clearing one or more logs stored in storage module 110. In some embodiments, technician 118 may access the time log information through the use of a data access device 116 that is remotely located from the time logging rig using a Bluetooth or Wi-Fi connection, or other wireless communication protocols (e.g., lower frequency radio frequency (RF) communication protocols, infrared (IR) communication protocols).

In some embodiments, interface 108 may be password-protected. Technician 118 may update the password using the interface 108. The password can be stored in storage module 110 and can be stored in either an encrypted or non-encrypted state. The one or more logs stored in storage module 110 may be encrypted and thus password protected.

Shipping container 100 may include power source 106. Power source 106 may be a battery or other power device configured to provide power to components within shipping container 100. Power source 106 may be configured to provide power to each of the sensor area 102, microcontroller 104, clock module 112, storage module 110 and interface 108.

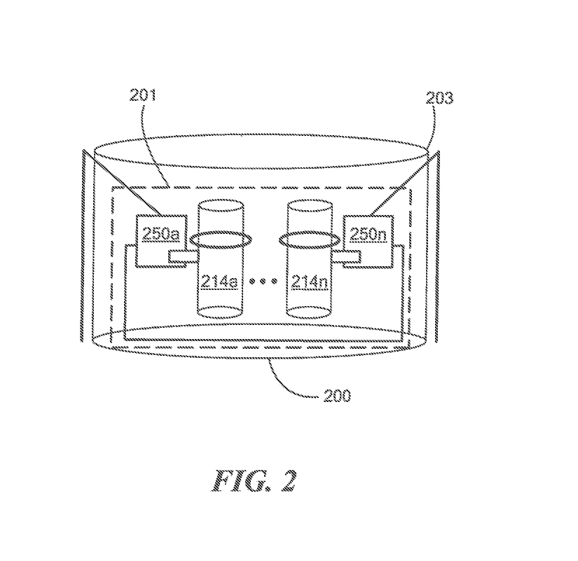

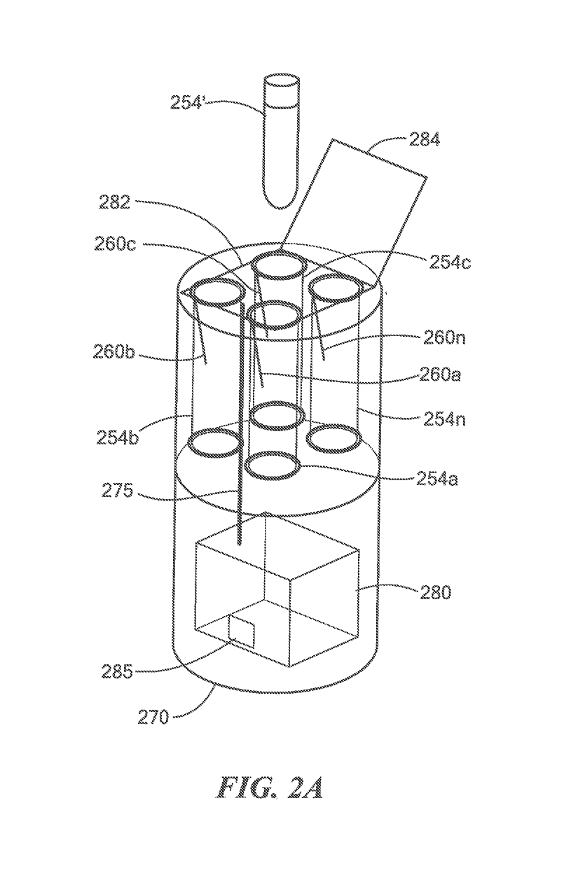

Now referring to FIG. 2, one or more sample collectors 214a-214n are disposed within a shipping container 200. Shipping container 200 includes an outer container 203 and an inner container 201. The outer container 203 may be an outer shell or surface of shipping container 200 and the inner container 201 can be an internal shell that is configured to house and protect one or more sample collectors 214a-214n and any electronics within shipping container 200.

Shipping container 200 may include one or more contact switches 250a-250n that can be in contact with one or more sample collectors 214a-214n when the sample collectors 214a-214n are disposed within inner container 201. The contact switches 250a-250n can be configured to detect the insertion, removal and/or replacement of the one or more sample collectors 214a-214n within inner container 201. In some embodiments, each contact switch 250 may be coupled to at least one sample collector 214. In other embodiments, a contact switch 250 may be coupled to two or more sample collectors 214. Contact switches 250a-250n may be same as or substantially similar to one of switches 103 of FIG. 1.

In an embodiment, the inner container 201 may include insulation material (e.g., foam inner container) to hold and protect sample collectors 214a-214n and contact switches 250a-250n. In some embodiments, each contact switch 250 may be coupled to or otherwise in contact with at least one sample collector 214. In other embodiments, a contact switch 250 may be coupled to or otherwise in contact with two or more sample collectors 214a-214n.

When a sample collector 214 is removed from inner container 201 and thus shipping container 200, at least one contact switch 250 can be activated and the date and time of the removal of respective sample collector 214 can be recorded as a sample collector removal event. Contact switches 250a-250n may include mechanical elements to detect motion of sample collectors 214a-214n. For example, and without limitation, contact switches 250a-250n may include, a lever to activate a switch, a momentary, semi-momentary, or toggle type switches. Thus, when one or more sample collectors 214a-214n is inserted back into shipping container 200, one or more contact switches 250a-250n may be activated and the date and time of corresponding sample collectors 214a-214n being returned to shipping container 200 and inner container 201 can be recorded as a sample collector return event. The date and entire time frame between one or more sample collectors 214a-214n being removed and returned to shipping container 200 and/or inner container 201 can be recorded as a sample collection event.

To record and store data associated with the sample collection event, shipping container 200 may be the same as or substantially similar to shipping container 100 described above with respect to FIG. 1. Thus, shipping container 200 may include one or more switches, one or more sample collectors, disposed in a sensor area, a microcontroller, a power source, a clock module, a storage module and an interface.

Now referring to FIG. 2A, one or more sample collector 254a-254n are disposed within a shipping container 270. Shipping container 270 may include a conductive surface 282 and container cap 284. Shipping container 270 can be configured to sense the opening and/or closing of the container cap 284 by sensing the opening and/or closing of a circuit formed between conductive surface 282 and container cap 284. For example, conductive surface 282 can be configured to complete a circuit with container cap 284. Conductive surface 282 may be coupled to a circuit 275 and container cap 284 may include conductive material formed on or otherwise disposed on an inner surface of container cap 284 (e.g., conductive ring). Thus, when conductive surface 282 is in contact with container cap 284, the circuit 275 is complete and thus closed. When container cap 284 is removed from shipping container 270, conductive surface 282 is no longer in contact with container cap 284 and the circuit 275 is open. Shipping container 270 can be configured to sense the opening and/or closing of circuit 275 formed between conductive surface 282 and container cap 284.

Shipping container 270 may include one or more switches 260a-260n that can be in contact with the one or more sample collectors 254a-254n when the sample collectors 254a-254n are disposed within shipping container 270. The switches 260a-260n can be configured to detect the insertion and/or replacement of the one or more sample collectors 254a-254n within shipping container 270 or the removal of the one or more sample collectors 254a-254n from shipping container 270. For example, in some embodiments, each switch 260a-260n may be coupled to at least one of the one or more sample collectors 254a-254n. In other embodiments, a switch 260 may be coupled to two or more sample collectors 254a-254n. Switches 260a-260n may be same as or substantially similar to one of switches 103 of FIG. 1 or contact switches 250a-250n of FIG. 2.

In an embodiment, when a sample collector 254′ is removed from shipping container 270, at least one switch 260 can be activated and the date and time of the removal of respective sample collector 254′ can be recorded as a sample collector removal event. Switches 260a-260n may include mechanical elements to detect motion of one or more sample collectors 254a-254n. For example, and without limitation, switches 260a-260n may include, a lever to activate a switch, a momentary, semi-momentary, or toggle type switches. Thus, when one or more sample collectors 254a-254n are inserted back into shipping container 270, one or more switches 260a-260n may be activated and the date and time of corresponding sample collectors 254a-254n being returned to shipping container 270 can be recorded as a sample collector return event. The date and entire time frame between one or more sample collectors 254a-254n being removed and returned to shipping container 270 can be recorded as a sample collection event.

Shipping container 270 may include electronics, such as microcontroller 280, to detect and record sample collection event information. For example, microcontroller 280 may be coupled to switches 260a-260n to detect the movement of one or more sample collectors 254a-254n. Microcontroller 280 may be coupled to circuit 275 to detect the completion of the circuit between conductive surface 282 and container cap 284. Microcontroller 280 may include a clock module and storage module to track and store the data corresponding to the sample collection event. For example, microcontroller 280 may log date and time information corresponding to the movement of one or more sample collectors 254a-254n. In some embodiments, microcontroller 280 may log date and time information corresponding to the completion of the circuit between conductive surface 282 and container cap 284.

Microcontroller 280 may generate and store the logs of data for each sample collection event in the storage module. In some embodiments, microcontroller may include an interface 285 configured to provide access to the logs of data in the storage module. The microcontroller 280, clock module, storage module and interface 285 may the same as or substantially similar to microcontroller 104, clock module 112, storage module 110 and interface 108 of FIG. 1.

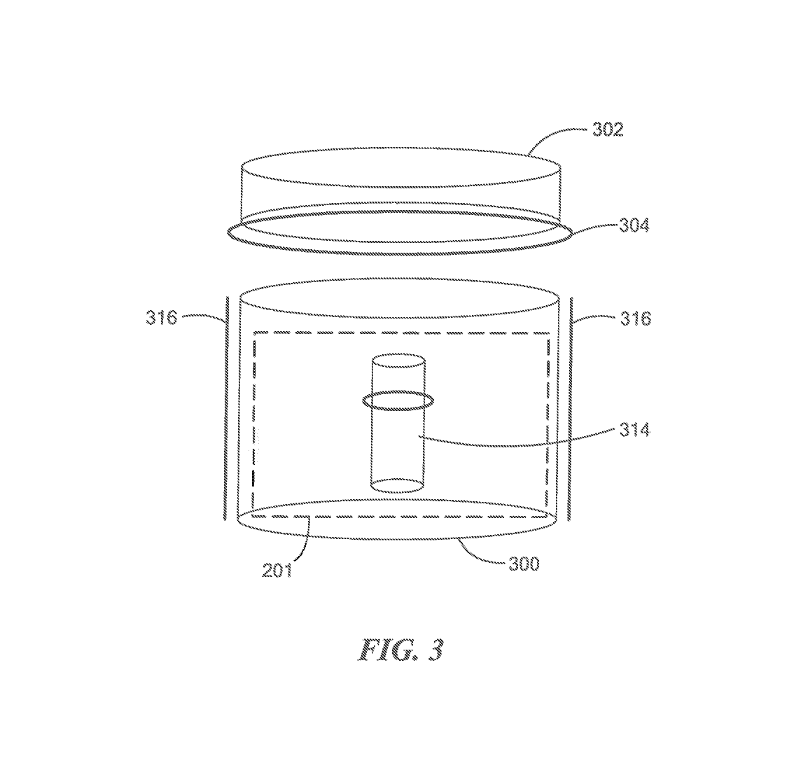

Now referring to FIG. 3, a sample collector 314 is disposed within a shipping container 300 having leads 316, a container cap 302 and a conductive ring 304. Shipping container 300 can include an outer container 303 and inner container 301. The outer container 303 may be an outer shell or surface of shipping container 300 and the inner container 301 can be an internal shell that is configured to house and protect sample collector 314 and any electronics within shipping container 300. Leads 316 can be formed on a surface of or within a surface of outer container 303, inner container 301 or both.

Shipping container 300 can be configured to sense the opening and/or closing of the container cap 322 by sensing the opening and/or closing of a circuit formed by conductive ring 304 and leads 316. For example, conductive ring 304 can be configured to complete a circuit with leads 316 when container cap 302 is coupled to shipping container 300 (and thus outer container 303 and/or inner container 301). When conductive ring 304 is in contact with leads 316 the circuit is complete and thus closed. When container cap 302 is removed from shipping container 300, conductive ring 304 is no longer in contact with leads 316 and the circuit is open. In some embodiments, shipping container 300 can detect the opening and/or closing of a first container cap coupled to outer container 303 and a second container cap coupled to inner container 301.

Shipping container 300 can be configured to record sample collection event information by sensing the opening and/or closing of container cap 302. For example, the opening of container cap 302 may initiate a sample collection event and the closing of container cap 302 may indicate the end of the sample collection event.

In some embodiments, the removal of the container cap 302 from shipping container 300 may be recorded as a cap removal event. The return of the container cap 302 to the shipping container 300 may be recorded as a cap return event. In an embodiment, both the cap removal event, cap return event may be included in the sample collection event information. Shipping container 300 can be configured to calculate a total time between the cap removal event and the cap return event that may correspond to a total time for the sample collection event. To record and store data associated with the sample collection event, shipping container 300 may be the same as or substantially similar to shipping container 100 described above with respect to FIG. 1. Thus, shipping container 300 may include one or more switches, one or more sample collectors, disposed in a sensor area, a microcontroller, a power source, a clock module, a storage module and an interface.

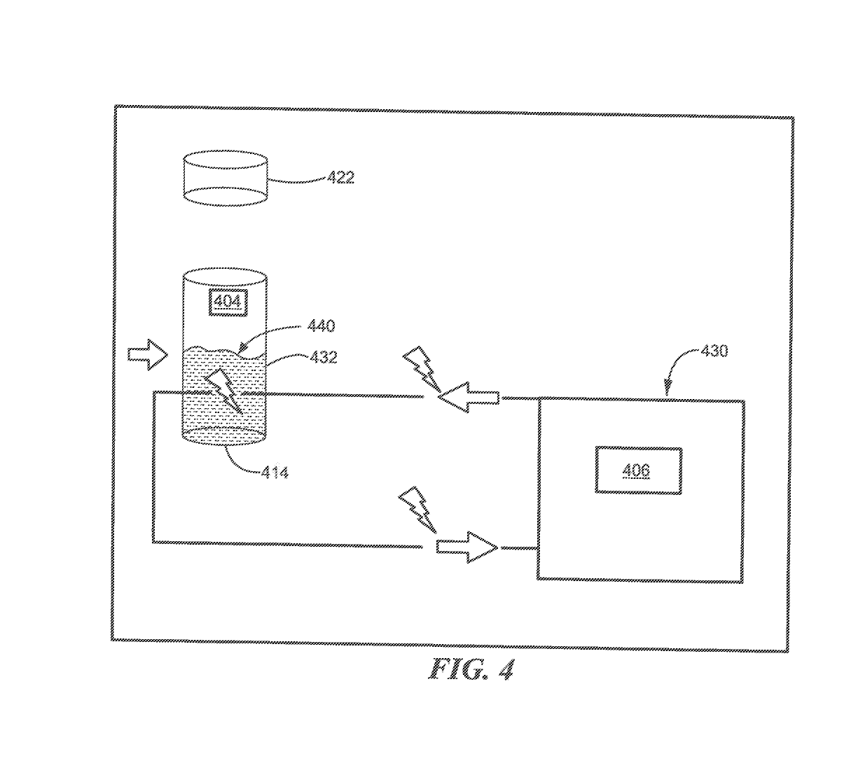

Now referring to FIG. 4, a sample collector 414 includes a container cap 422 and a sensor 432. In an embodiment, sensor 432 may be configured to detect the presence of a sample 440 (e.g., body fluid and/or tissue) within sample collector 414. For example, when the sample 440 is received and collected inside sample collector 414.

Sensor 432 can be included within sample collector 414 or positioned along inner walls (e.g., an inner surface) of sample collector 414. In some embodiments, multiple sensors 432 may be disposed within sample collector 414. Sensor 432 can include a lead and/or any form of conductive material. Sensor 432 can be configured to recognize by electrical conduction the presence of the sample inside sample collector 414. For example, the sample 440 itself can complete a circuit through the conductive properties of the sample 440, such as ions in a blood sample, connecting to leads on the body or inside portion of sample collector 414. The addition of the sample 440 to sample collector 414 can complete the circuit and the date and time of the action can be recorded as a sample collection event. In some embodiments, the electrical conduction through the sample 440 is recognized by optical density, ultrasound detection, or any other such device and this activity is recognized and recorded.

Sample collector 414 may include electronics, such as microcontroller 404, to detect and record sample collection event information. For example, microcontroller 404 may be coupled to sensors 432 to detect the completion of the circuit between sensor 432 and sample 440. Microcontroller 404 may include a clock module and storage module to track and store the data corresponding to the sample collection event. For example, microcontroller 404 may log date and time information corresponding to the completion of the circuit between sensor 432 and sample 440 using the clock module. Microcontroller 404 may generate and store the logs of data for each sample collection event in the storage module. In some embodiments, microcontroller may include an interface configured to provide access to the logs of data in the storage module. The microcontroller 404, clock module, storage module and interface may the same as or substantially similar to microcontroller 104, clock module 112, storage module 110 and interface 108 of FIG. 1.

Sample collector 414 may be communicatively coupled to a shipping container 430 having a microcontroller 406 (e.g., such as shipping container 100 and microcontroller 104 of FIG. 1). Sample collector 414 may be the same as or substantially similar to sample collectors 114a-114n of FIG. 1. Sample collector 414 may be configured to transmit a signal indicating the presence of the sample. In some embodiments, the signal may be transmitted using a Bluetooth or Wi-Fi connection. In other embodiments, when sample collector 414 is re-inserted into shipping container 430, sample collector 414 can include electronics to plug into a sensor area and transmit the sample collection event information. For example, in one embodiment sample collector 414 may transmit the sample collection event information through a USB connection to microcontroller 406 of shipping container 430.

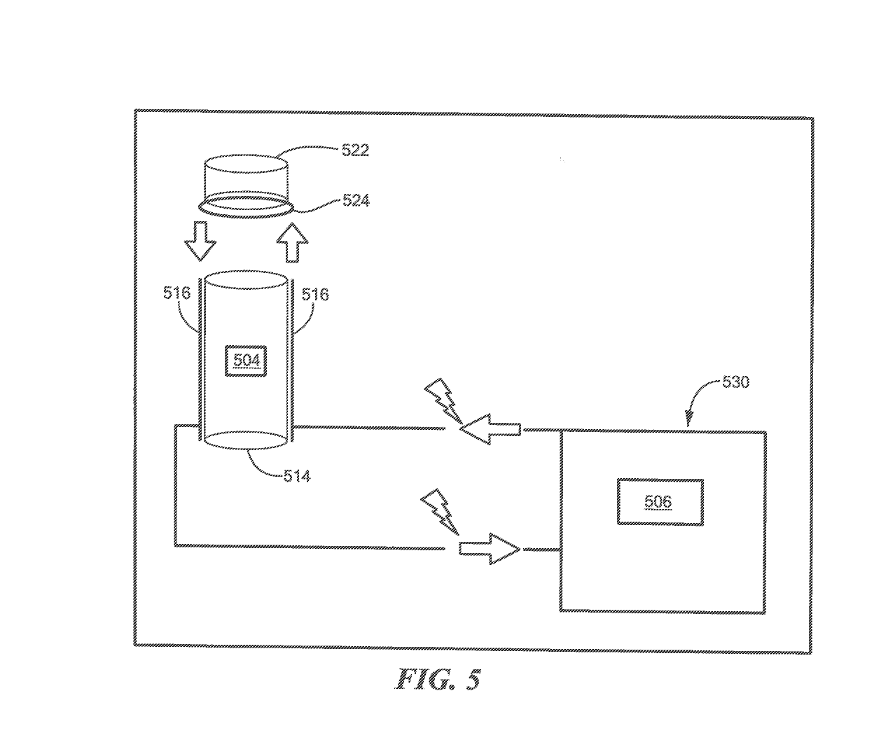

Referring now to FIG. 5, a sample collector 514 includes leads 516, a container cap 522 and a conductive ring 524 disposed around an inner circumference of container cap 522. In an embodiment, sample collector 514 can be configured to sense the opening and/or closing of the container cap 522 by sensing the opening and/or closing of a circuit formed by conductive ring 524 and leads 516. For example, conductive ring 524 can be configured to complete a circuit with leads 516 when container cap 522 is coupled to sample collector 514. When conductive ring 524 is in contact with leads 516 the circuit is complete and thus closed. When container cap 522 is removed from sample collector 514, conductive ring 524 is no longer in contact with leads 516 and the circuit is open.

Conductive ring 524 may include conductive material and may be disposed along an inner circumference of container cap 522. Leads 516 may include conductive material and may be disposed along the body of sample collector 514. In some embodiments, leads 516 may be formed within an inner wall of sample collector 514 and a portion of leads 516 may exposed near a top portion of sample collector 514 to make contact with conductive ring 524. Thus, the contact between conductive ring 524 and leads 516 may close the circuit.

The opening and/or closing of a circuit formed by conductive ring 524 and leads 516 may correspond to a sample collection event. By sensing the opening and/or closing of container cap 522, sample collector 514 can record sample collection event information. The opening of container cap 522 may initiate a sample collection event and the closing of container cap 522 may indicate the end of the sample collection event.

For example, the time period between the opening of the circuit formed by conductive ring 524 and leads 516 and the closing of the circuit formed by conductive ring 524 and leads 516 may correspond to a sample collection event. In some embodiments, the removal of the container cap 522 from sample collector 514 may be recorded as a cap removal event. The return of the container cap 522 to the sample collector 514 may be recorded as a cap return event. In an embodiment, both the cap removal event, cap return event may be included in the sample collection event information. Sample collector 514 can be configured to calculate a total time between the cap removal event and the cap return event that may correspond to a total time for the sample collection event.

Sample collector 514 may include electronics, such as microcontroller 504, to detect and record sample collection event information. For example, microcontroller 504 may be coupled to leads 516 to detect the opening and/or the closing of the circuit formed by conductive ring 524 and leads 516. Microcontroller 504 may include a clock module and storage module to track and store the data corresponding to the sample collection event. For example, microcontroller 504 may log date and time information corresponding to the opening and closing of the circuit formed by conductive ring 524 and leads 516 using the clock module. Microcontroller 504 may generate and store the logs of data for each sample collection event in the storage module. In some embodiments, microcontroller may include an interface configured to provide access to the logs of data in the storage module. The microcontroller 504, clock module, storage module and interface may the same as or substantially similar to microcontroller 104, clock module 112, storage module 110 and interface 108 of FIG. 1.

Sample collector 514 may be communicatively coupled to a shipping container 530 having a microcontroller 506 (e.g., such as shipping container 100 and microcontroller 104 of FIG. 1). For example, sample collector 514 may have been shipped in the shipping container 530 and may be the same as or substantially similar to sample collectors 114a-114n of FIG. 1. Sample collector 514 may be configured to transmit a signal indicating at least one of the removal of the cap, the return of the cap or the time between the removal of the cap and the return of the cap to the microcontroller of the shipping container. Thus, the signal may include the sample collection event information. In some embodiments, the signal may be transmitted using a Bluetooth, Wi-Fi connection or other wireless communication protocol. In other embodiments, when sample collector 514 is re-inserted into shipping container 530, sample collector 514 can include electronics to plug into a sensor area and transmit the sample collection event information. For example, in one embodiment sample collector 514 may transmit the sample collection event information through a USB connection to microcontroller 506 of shipping container 530.

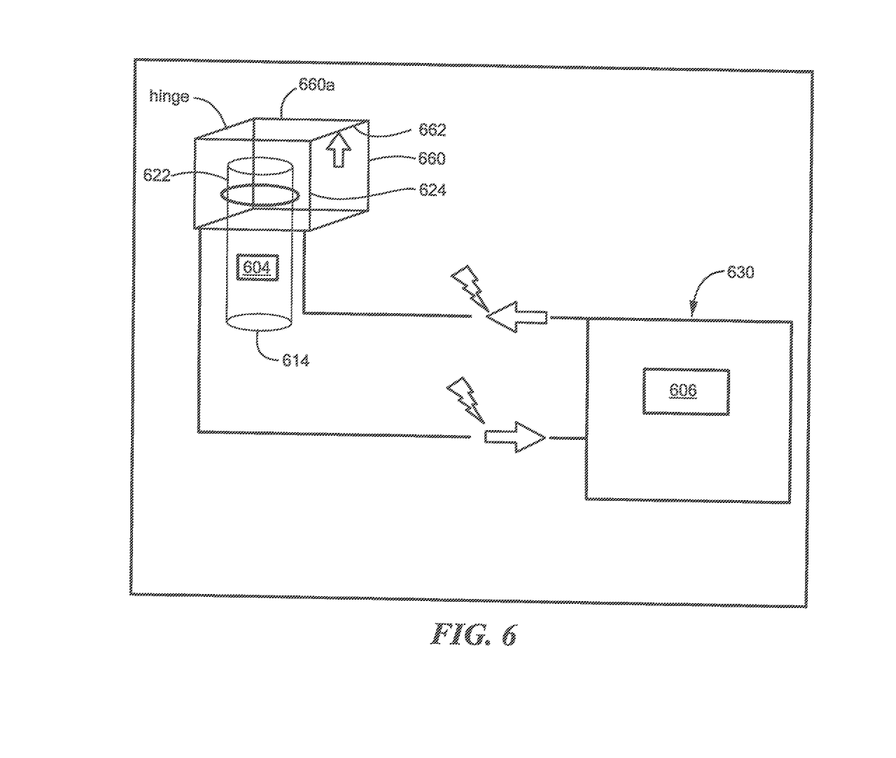

Now referring to FIG. 6, a sample collector 614 includes a container cap 622 and a cap guard device 660 disposed on or otherwise coupled to container cap 622. In an embodiment, cap guard device 660 may be a protective device (e.g., child resistant bottle cap) to control (e.g., prevent, restrict) the opening of the sample collector 614 by certain groups (e.g., children) and/or to protect the sample collector 614 and container cap 622 from damage, such as damage from being dropped.

A top surface 660a cap guard device 660 can be opened to provide access to container cap 622. It should be appreciated that in other embodiments, other surfaces, such as a side wall or side surface of cap guard device 660 can be configured to be opened and closed to provide access to container cap 622. Cap guard device 660 may include a cap guard switch 662 that can be configured to detect the opening and/or closing of cap guard device 660.

Sample collector 614 can be configured to sense the opening and/or closing of the cap guard device 660 and/or the activation of switch 662. Switch 662 may include a latch switch and may be the same as or substantially similar to one of switches 103 described above with respect to FIG. 1. In some embodiments, cap guard device 660 may include conductive material 624 disposed on an inner surface of the cap guard device and the movement of switch 662 may open and/or close a circuit formed by between switch 662 and conductive material 624. When switch 662 is in contact with conductive material 624 circuit is complete and thus closed. When switch 662 is opened and no longer in contact with conductive material 624, the circuit is open.

In an embodiment, the opening of switch 662 may be recorded as an open switch event and the closing of switch 662 may be recorded as a close switch event. The time period between the open switch event and the close switch event may correspond to a total time period for a sample collection event. Thus, in this embodiment, the recorded activity corresponds to when a patient opens and closes the cap guard device 660 of sample collector 614. The sample collection event may include (be a combination of) the open switch event and close switch event and may include a time period corresponding to the start of the open switch event until the close switch event is complete.

Sample collector 614 may include electronics, such as microcontroller 604, to detect and record sample collection event information. For example, microcontroller 604 may be coupled to conductive material 624 and/or switch 662 to detect the opening and/or closing of the circuit between switch 662 and conductive material 624. Microcontroller 604 may include a clock module and storage module to track and store the data corresponding to the sample collection event. For example, microcontroller 604 may log date and time information corresponding to the completion of the circuit between switch 662 and conductive material 624 using the clock module. Microcontroller 604 may generate and store the logs of data for each sample collection event in the storage module. In some embodiments, microcontroller may include an interface configured to provide access to the logs of data in the storage module. The microcontroller 604, clock module, storage module and interface may the same as or substantially similar to microcontroller 104, clock module 112, storage module 110 and interface 108 of FIG. 1.

Sample collector 614 may be communicatively coupled to a shipping container 630 having a microcontroller 606 (e.g., such as shipping container 100 and microcontroller 104 of FIG. 1). Sample collector 614 may be the same as or substantially similar to sample collectors 114a-114n of FIG. 1. Sample collector 614 may be configured to transmit a signal indicating the opening and/or closing of cap guard device 660 and/or opening of container cap 622. In some embodiments, the signal may be transmitted using a Bluetooth or Wi-Fi connection. In other embodiments, when sample collector 614 is re-inserted into shipping container 630, sample collector 614 can include electronics to plug into a sensor area and transmit the sample collection event information. For example, in one embodiment sample collector 614 may transmit the sample collection event information through a USB connection to microcontroller 606 of shipping container 630.

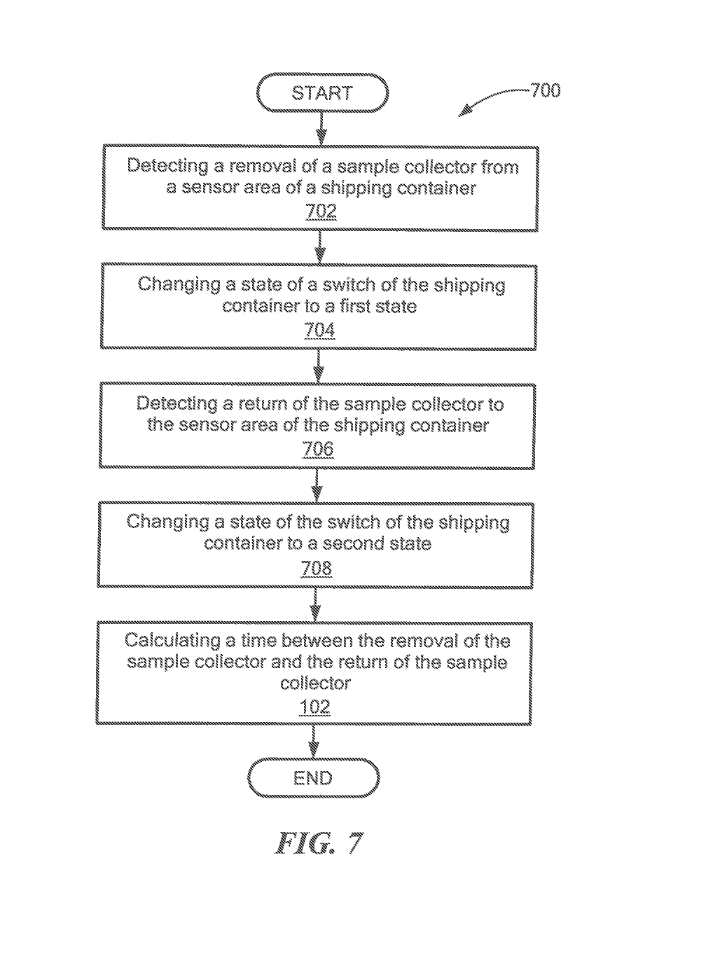

Now referring to FIG. 7, a method 700 for recording a sample collection event, begins at block 702, wherein a removal of a sample collector from a sensor area of a shipping container can be detected. In an embodiment, a shipping container can be configured to detect the removal of one or more sample collectors from the shipping container. For example, the sample collectors may be disposed on or otherwise positioned in a sensor area of the shipping container. The sensor area may include one or more switches coupled to the sensor area. The switches can be configured to detect any movement of the sample collectors.

At block 704, a state of one or more switches of the shipping container can be changed to a first state. In some embodiments, responsive to the movement of one or more sample collectors, the state of one or more switches may be changed to the first state. The first state may indicate that one or more sample collectors have been removed from the shipping container and/or the initiation of a sample collection event.

The switch may be coupled (e.g., communicatively, directly) to a microcontroller of the shipping container. The switch may transmit a signal indicating the change of state to the microcontroller. For example, in some embodiments, the signal may include a hardware interrupt to modify an activity level of the microcontroller. The signal may cause a change in a power level of the microcontroller. For example, the responsive to changing the state of the switch, a power level of a microcontroller may change from a first level to a second level to record data corresponding to the sample collection event. The first level may be a low-power or stand-by power level (e.g., sleep mode). The second level may be an active mode.

The microcontroller may be coupled to a clock module of the shipping container. In some embodiments, responsive to changing the state of the switch to the first state, a power level of the clock module may change from a first level to a second level to record time date corresponding to the sample collection event. The clock module may begin recording time data for the sample collection event. The time data may include a time for when the sample collector was removed (e.g., sample collection removal event) from the shipping container and activate a running clock to cover a total time period for the sample collection event.

At block 706, a return of the sample collector to the sensor area of the shipping container can be detected. In an embodiment, the shipping container can be configured to detect the insertion and/or replacement of one or more sample collectors into the shipping container. The sample collectors may be returned to the sensor area of the shipping container. The one or more switches coupled to the sensor area can be configured to detect the movement of the sample collectors.

At block 708, the state of the switch of the shipping container can be changed to a second state. In an embodiment, responsive to the return of one or more sample collectors, the switch may change to a second state. The second state may indicate that one or more sample collectors have been re-inserted into the shipping container and that the sample collection event is over.

The switch may transmit a signal indicating the change of state to the microcontroller. The signal may cause a change in a power level of the microcontroller. For example, the responsive to changing the state of the switch, a power level of a microcontroller may change from the second level to the first level. In some embodiments, the microcontroller may transmit a signal to the clock module to stop recording time data for the sample collection event.

At block 710, a time between the removal of the sample collector and the return of the sample collector can be calculated. The clock module may record a time when the sample collector is returned to the shipping container (sample collector return event) and record the total time for the sample collection event. The clock module may transmit a signal to the microcontroller including the time data for the sample collection event. The time date may include the sample collector removal event data, the sample collector return data and the total time for the sample collection event.

The sample collection event data may include the entire sequence from the removal of one or more sample collectors from shipping container 100 to the replacement of the one or more sample collectors. This time can be recorded and stored as the sample collection event information in a storage module of the shipping container. in a memory device or database or some other type of storage element.

In one embodiment, a patient may use a sample collector to take a sample of body fluid (e.g., blood sample) or tissue to be analyzed at a lab. The patient can remove the sample collector from the shipping container, open the sample collector and insert the appropriate sample. The patient can close the sample collector and replace (e.g., re-insert) the sample collector into the shipping container. The sequence event from the opening of the shipping container and/or opening of the sample collector to the closing of the shipping container and/or the closing of the sample collector may be referred to herein as a sample collection event. The shipping container can then be transported to a lab for a technician to analyze the contents within the sample collector. The period of time required to remove the sample collector, fill the sample collector with a sample (e.g., blood from finger stick) and return to the sample collector to the shipping container provides an objective record of date and time of the sample collection event.

A threshold time limit (e.g. a time limit) can be used to determine a proper sample collection event. For example, a patient cannot remove the sample collector and fill at leisure and then return to the sample collector to shipping container without the extended time being unrecorded, thereby failing the collection time interval criteria (e.g., <5 min.) and thereby rejected as a sample for analysis. Thus, the microcontroller can be configured to compare the sample collection event time data to a threshold limit to determine if the sample collection event is a proper collection event. If the time data exceeds the threshold time limit, the sample collection event may be flagged in the storage module to alert a technician when later analyzing the sample collection date. If the time data is less than the threshold time limit, the sample collection event may be marked as good in the storage module. It should be appreciated that different sample collection events may have different threshold time limits, based at least in part on the number of sample collectors to be utilized and/or a time requirement to collect the sample (e.g., type of sample being taken from patient).

In some embodiments, the detection of movement of a cap of the sample collector may be recorded and stored as a sample collection event. For example, a removal of a cap of the sample collector can be detected. The sample collector may include conductive material disposed on otherwise formed on a surface of the sample collection and the cap may include a conductive ring. Thus, the removal of the cap may open a circuit between the cap and the sample collector. The removal of the cap can be recorded as a cap removal event. A return of the cap to the sample collector can be detected. The return of the cap may close the circuit between the cap and the sample collector. The return of the cap may be recorded as cap return event. A time between the between the removal of the cap and the return of the cap can be calculated and may correspond to the sample collection event.

A signal may be transmitted indicating at least one of: the removal of the cap, the return of the cap or the time between the removal of the cap or the return of the cap to the microcontroller of the shipping container. The sample collector may be communicatively coupled to the microcontroller. In some embodiments, the signal may be transmitted using a Bluetooth, Wi-Fi or other form of wireless connection. In other embodiments, when sample collector is re-inserted into the shipping container, the sample collector can include electronics to plug into a sensor area and transmit the sample collection event information. For example, in one embodiment, the sample collector may transmit the sample collection event information through a USB connection to the microcontroller.

In some embodiments, a presence of a sample in the sample collector can be detected by a sensor to indicate a sample collection event. The sample collector may include a sensor (e.g., conductive material) that is disposed on or otherwise formed on an inner surface (e.g., inner wall, inner base) of the sample collector. The sample, when disposed within the sample collector, can complete a circuit between properties of the sample and sensor. For example, in one embodiment, the sensor can detect, by electrical conduction, the presence of the sample inside the sample collector. A date and time when the circuit is completed (e.g., when the sample is disposed within the sample collector) can be calculated and recorded as a sample collection event.

The sample collector may include a cap guard device that can be configured to control access to a cap of the sample collector and/or the sample collector. One or more surfaces (e.g., top surface, side surface) of the cap guard device can be opened to access the sample collector. The cap guard device may include a cap guard switch that can be configured to detect the opening and/or closing of cap guard device.

The opening and/or closing of the cap guard device (e.g., activation of switch 662) can be recorded as a sample collection event. For example, the opening of the switch may be recorded as an open switch event and the closing of the switch may be recorded as a close switch event. The time period between the open switch event and the close switch event may correspond to a total time period for the sample collection event. The sample collection event may include (be a combination of) the open switch event and close switch event and may include a time period corresponding to the start of the open switch event until the close switch event is complete.

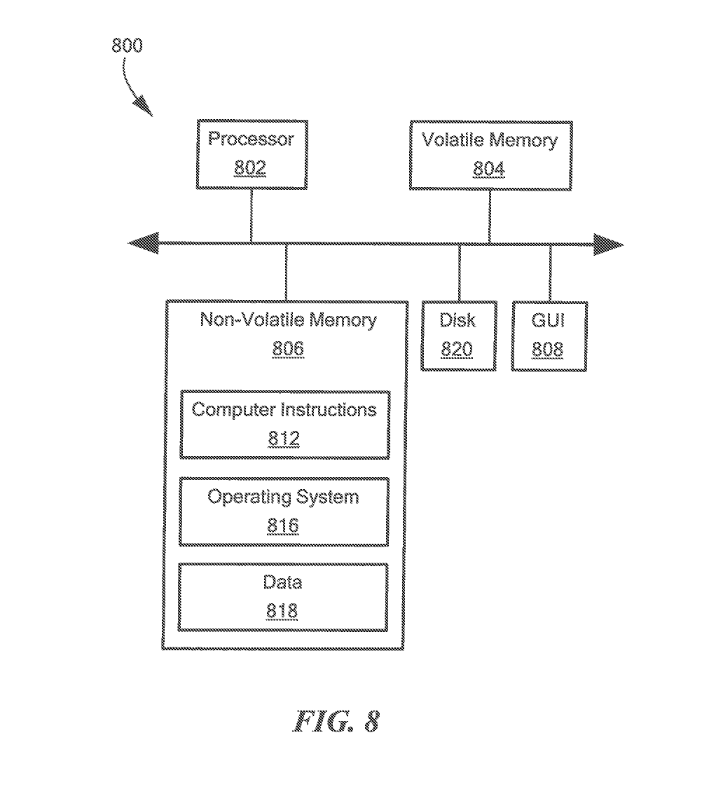

Referring now to FIG. 8, a computer 800 includes a processor 802, a volatile memory 804, a non-volatile memory 806 (e.g., hard disk), a graphical user interface (GUI) 808 (e.g., a mouse, a keyboard, a display, for example) and a computer disk 820. The non-volatile memory 806 stores computer instructions 812, an operating system 816 and data 818. In an embodiment, the data 818 may correspond to sample collection event information, including time data, sample collector data, shipping container data and/or patient data. In some embodiments, non-volatile memory 806 includes logs and/or look-up tables that store and organizes data corresponding to the sample collection event information. In one example, the computer instructions 812 are executed by the processor 802 out of volatile memory 804 to perform all or part of the method (or process) 700 of FIG. 7.

In an embodiment, computer 800 may be the same as or substantially similar to each of microcontroller 104, storage module 110, interface 108 and data access device 116 of FIG. 1. Computer 800 may perform all of the same functions and be configured to receive and generate the same data as each of microcontroller 104, storage module 110, interface 108 and data access device 116 of FIG. 1, as described herein. For example, computer 800 may be configured to record and store sample collection event information for one or more sample collection events and/or perform the techniques described above with respect to method 700.

Method 700 is not limited to use with the hardware and software of FIG. 8; they may find applicability in any computing or processing environment and with any type of machine or set of machines that is capable of running a computer program. Method 700 may be implemented in hardware, software, or a combination of the two. Method 700 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform method 700 and to generate output information.

The system may be implemented, at least in part, via a computer program product, (e.g., in a machine-readable storage device), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment.

A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform method 700. Method 700 may also be implemented as a machine-readable storage medium, configured with a computer program, where upon execution, instructions in the computer program cause the computer to operate in accordance with method 700.

Method 700 may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

With each of the embodiments as described herein, when the events have been recorded the records can be uploaded to a central database or file via a plug in (i.e., USB connection) or through wireless technology such as Bluetooth or Wi-Fi (i.e., SD card Wi-Fi).

It should be appreciated that the described herein may be performed by circuits, such as a digital signal processor circuit, an application specific integrated circuit (ASIC), a field programmable gate array (FPGA), or conventional electrical or electronic systems or circuits. Some processing may be manually performed, while other processing may be performed by circuitry and/or one or more processors. It should be noted that unless otherwise indicated herein, the particular sequences or processes described are illustrative only and can be varied without departing from the spirit of the concepts described and/or claimed herein. Thus, unless otherwise stated, the processes described are unordered meaning that, when possible, the sequences described can be performed in any convenient or desirable order.

While particular embodiments of concepts, systems, circuits and techniques have been shown and described, it will be apparent to those of ordinary skill in the art that various changes and modifications in form and details may be made therein without departing from the spirit and scope of the concepts, systems and techniques described herein. For example, some of the presented implementation examples illustrate a collection system having a battery as a power source. It will be appreciated that the concepts described herein can be used with any type of power source. Also, in some embodiments, adapted (or dynamically computed) collection related values may be recorded substantially continuously (e.g. with analog signals) while in other embodiments the collection values may be recorded at discrete points in time. Other combination or modifications are also possible all of which will be readily apparent to one of ordinary skill in the art after reading the disclosure provided herein.

Having described preferred embodiments which serve to illustrate various concepts, systems circuits and techniques, which are the subject of this patent, it will now become apparent to those of ordinary skill in the art that other embodiments incorporating these concepts, systems circuits and techniques may be used. For example, it should be noted that individual concepts, features (or elements) and techniques of different embodiments described herein may be combined to form other embodiments not specifically set forth above. Furthermore, various concepts, features (or elements) and techniques, which are described in the context of a single embodiment, may also be provided separately or in any suitable sub-combination. It is thus expected that other embodiments not specifically described herein are also within the scope of the following claims.

In addition, it is intended that the scope of the present claims include all other foreseeable equivalents to the elements and structures as described herein and with reference to the drawing figures. Accordingly, the subject matter sought to be protected herein is to be limited only by the scope of the claims and their equivalents.

It should thus be appreciated that elements of different embodiments described herein may be combined to form other embodiments which may not be specifically set forth herein. Various elements, which are described in the context of a single embodiment, may also be provided separately or in any suitable sub-combination. Other embodiments not specifically described herein are also within the scope of the following claims.

It is felt, therefore that the concepts, systems, circuits and techniques described herein should not be limited by the above description, but only as defined by the spirit and scope of the following claims which encompass, within their scope, all such changes and modifications.

All publications and references cited herein are expressly incorporated herein by reference in their entirety.

What is claimed:

1. A system for recording a sample collection event, the system comprising:
a shipping container comprising a sensor area, a switch and a microcontroller; and
sample collector positioned on the sensor area of the shipping container, wherein the removal of the sample collector from the sensor area changes a state of the switch to a first state and the return of the sample collector to the sensor area changes the state of the switch to a second state during the sample collection event and wherein the microcontroller is coupled to the switch to receive a signal from the switch indicating the change in state.

2. The system of claim 1, wherein the microcontroller, responsive to receiving the signal from the switch, changes from a first power level to a second power level to record and store data corresponding to the sample collection event.

3. The system of claim 1, further comprising a clock module coupled to the microcontroller, wherein the clock module is configured to record time data corresponding to the sample collection event and transmit the time data to the microcontroller.

4. The system of claim 1, further comprising a storage module coupled to the microcontroller, wherein the microcontroller is configured to generate and store logs for one or more sample collection events in the storage module, wherein each log includes time data, date data, patient data, sample collector data or shipping container data corresponding to the respective one or more sample collection events.

5. The system of claim 1, further comprising an interface coupled to the microcontroller, wherein the interface is configured to provide data corresponding to the sample collection event to one or more computing devices coupled to the shipping container.

6. The system of claim 1, wherein the shipping container comprises a plurality of sensor areas and a plurality of switches, wherein each sensor area is configured to hold one or more sample collectors and each switch is coupled to at least one sensor area and wherein the microcontroller is coupled to each of the plurality of switches to receive the signal from the respective switch indicating the change in state of the respective switch.

7. A system for recording a sample collection event, the system comprising:
a sample collector comprising a conductive material; and
a cap positioned on the sample collector, the cap comprising a conductive ring, and the conductive ring coupled to the conductive material of the sample collector to form a circuit between the cap and the sample collector;
wherein the removal of the cap from the sample collector opens a circuit established between the cap and the sample collector and the return of the cap to the sample collector closes circuit between the cap and the sample collector.

8. The system of claim 7, further comprising a shipping container having a microcontroller, wherein the sample collector is communicatively coupled to the microcontroller, and wherein the microcontroller is configured to detect the opening and closing of the circuit between the cap and the sample collector and record data corresponding to the sample collection event responsive to the opening and closing of the circuit.

9. The system of claim 8, further comprising a cap guard disposed over the cap, wherein the cap guard is configured to open and close to control access to the cap and sample collector, and wherein the microcontroller is configured to detect the opening and the closing of the cap guard.

10. The system of claim 8, wherein the sample collector comprises at least one sensor positioned within the sample collector to detect a presence of a sample in the sample collector, wherein the presence of the sample within the sample collector activates a circuit between the sample and the sensor in the sample collector.

11. The system of claim 10, wherein the microcontroller is configured to detect the activation of the circuit between the sample and the sensor in the sample collector and record data corresponding to the sample collection event responsive to the activation of the circuit.

12. The system of claim 10, wherein the sensor is disposed on an inner surface of the sample collector and the sensor is configured to detect, by electrical conduction, the presence of the sample inside the sample collector.

13. A method for recording a sample collection event, the method comprising:
detecting a removal of a sample collector from a sensor area of a shipping container;
changing a state of a switch of the shipping container to a first state;
detecting a return of the sample collector to the sensor area of the shipping container;
changing the state of the switch of the shipping container to a second state; and
calculating a time between the removal of the sample collector and the return of the sample collector.

14. The method of claim 13, further comprising, responsive to changing the state of the switch, changing a power level of a microcontroller of the shipping container from a first level to a second level to record data corresponding to the sample collection event.

15. The method of claim 14, further comprising responsive to changing the state of the switch to the first state, changing a power level of a clock module of the shipping module from a first level to a second level to record time date corresponding to the sample collection event.

16. The method of claim 14, further comprising, responsive to the changing the state of the switch to the second state, changing the power level of a microcontroller of the shipping container from the second level to the first level to stop recording data corresponding to the sample collection event.

17. The method of claim 14, further comprising:
detecting a removal of a cap of the sample collector, the removal opening a circuit between the cap and the sample collector;
detecting a return of the cap to the sample collector, the return closing the circuit between the cap and the sample collector; and
calculating a time between the removal of the cap and the return of the cap.

18. The method of claim 17, further comprising transmitting a signal indicating at least one of the removal of the cap, the return of the cap or the time between the removal of the cap and the return of the cap to the microcontroller of the shipping container.

19. The method of claim 13, further comprising:
detecting a presence of a sample in the sample collector, the sample completing a circuit between properties of the sample and conductive material coupled to an inner surface of the sample collector; and
calculating a date and time when the circuit is completed in the sample collector.

20. The method of claim 19, further comprising detecting by electrical conduction the presence of the sample inside the sample collector, wherein the conductive material is disposed on an inner surface of the sample collector.
